(19) United States
(12) Patent Application Publication
(10) Pub. No.: US 2015/0334271 A1
(43) Pub. Date: Nov. 19, 2015

(54) Crane Boom Camera Device

(71) Applicant: Charles Hartig, Loxachatchee, FL (US)

(72) Inventor: Charles Hartig, Loxachatchee, FL (US)

(21) Appl. No.: 14/640,076

(22) Filed: Mar. 6, 2015

Related U.S. Application Data
(60) Provisional application No. 61/994,263, filed on May 16, 2014.

(51) Int. Cl. H04N 5/225; B60R 1/00; G03B 17/56

(52) U.S. Cl. CPC H04N 5/2251; G03B 17/561; B60R 1/00

(57) ABSTRACT

A crane boom camera device attaches to a distal end of a boom arm relative to a crane cab for facilitating positioning of the boom arm. The device includes a coupler coupled to a base for coupling the base to a distal end of a boom arm of a crane relative to a body of the crane. A center of gravity of a camera pivotally coupled to the base is offset from a pivot point of the camera and the base such that a lens of the camera faces downward. The camera provides images to be viewed on a monitor showing images of a bucket coupled to the boom arm when the camera is coupled to the boom arm substantially in vertical alignment with the bucket.

### CROSS REFERENCE TO RELATED APPLICATIONS

This application claims the benefit of the provisional application 61/994,263 filed on May 16, 2014.

### BACKGROUND OF THE DISCLOSURE

1. Field of the Disclosure

The disclosure relates to camera devices and more particularly pertains to a new camera device for attaching to a distal end of a boom arm relative to a crane cab for facilitating positioning of the boom arm.

2. Summary of the Disclosure

An embodiment of the disclosure meets the needs presented above by generally comprising a coupler coupled to a base for coupling the base to a distal end of a boom arm of a crane relative to a body of the crane. A center of gravity of a camera pivotally coupled to the base is offset from a pivot point of the camera and the base such that a lens of the camera faces downward. The camera provides images to be viewed on a monitor showing images of a bucket coupled to the boom arm when the camera is coupled to the boom arm substantially in vertical alignment with the bucket.

There has thus been outlined, rather broadly, the more important features of the disclosure in order that the detailed description thereof that follows may be better understood, and in order that the present contribution to the art may be better appreciated.

There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a front partially detailed view of a crane boom camera device according to an embodiment of the disclosure.

FIG. 2 is a side view of an embodiment of the disclosure.

FIG. 3 is a front view of a monitor of an embodiment of the disclosure.

FIG. 4 is a side view of an embodiment of the disclosure.

FIG. 5 is a side view of an embodiment of the disclosure in use.

### DESCRIPTION OF THE PREFERRED EMBODIMENT

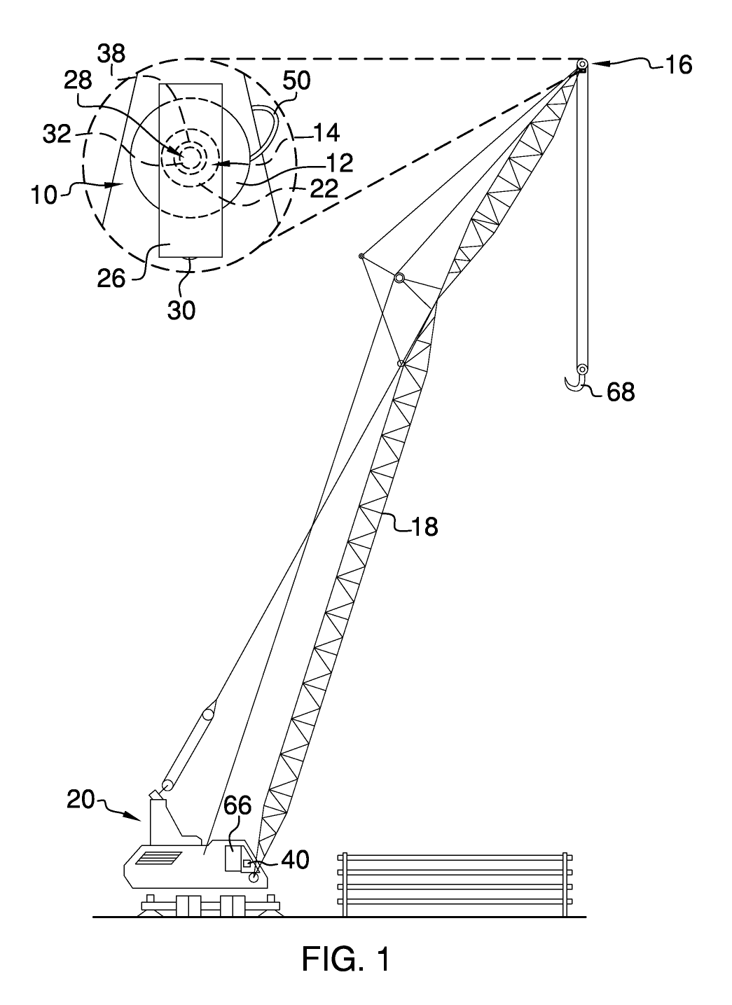

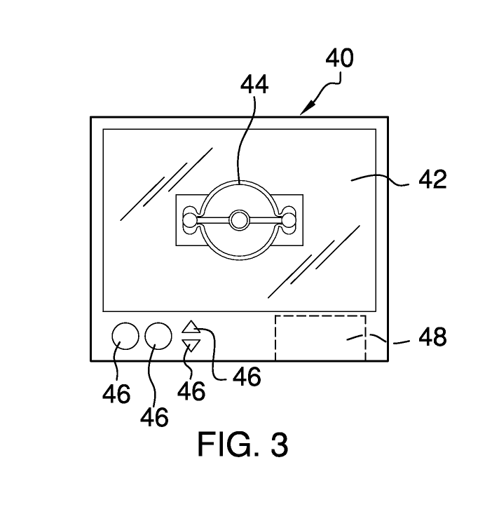

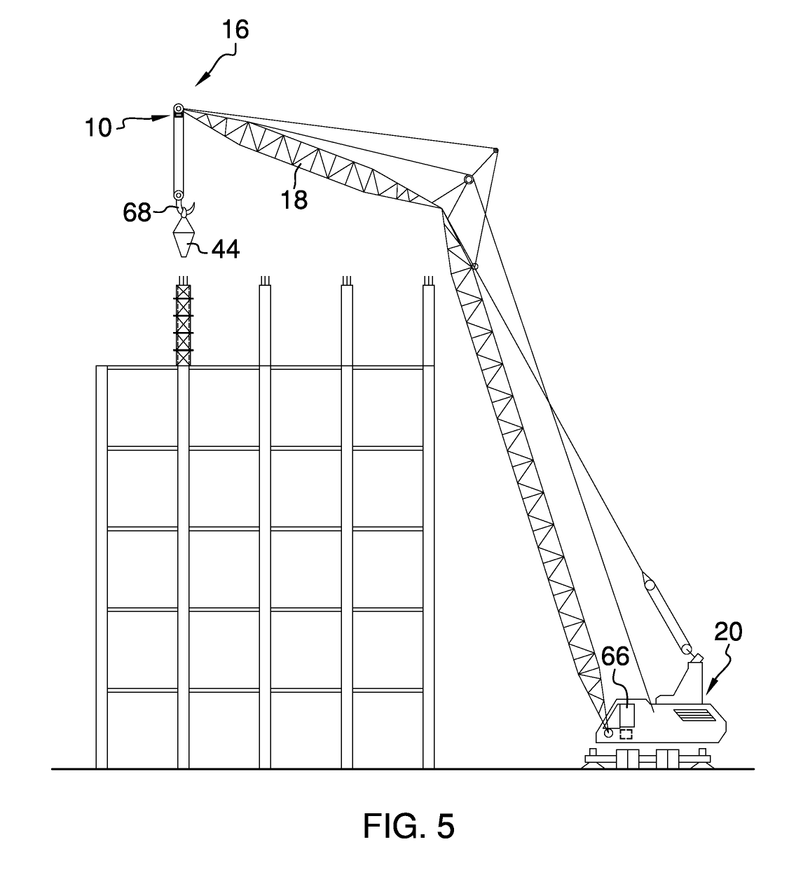

With reference now to the drawings, and in particular to FIGS. 1 through 5 thereof, a new camera device embodying the principles and concepts of an embodiment of the disclosure and generally designated by the reference numeral 10 will be described.

As best illustrated in FIGS. 1 through 5, the crane boom camera device 10 generally comprises a base 12 and a coupler 14 coupled to the base 12. The base 12 is disc-shaped. The coupler 14 is configured for coupling the base 12 to a distal end 16 of a boom arm 18 relative to a cab 66 of a crane 20. The coupler 14 is a magnet 22, or the like, centrally positioned on a face 24 of the base 12. The coupler 14 is flush with the face 24 of the base 12. A camera 26 is pivotally coupled to the base 12. A center of gravity of the camera 26 is offset from a pivot point 28 of the camera 26 and the base 12 such that a lens 30 of the camera 26 faces downward and maintains a downward orientation as the boom arm 18 of the crane 20 is moved.

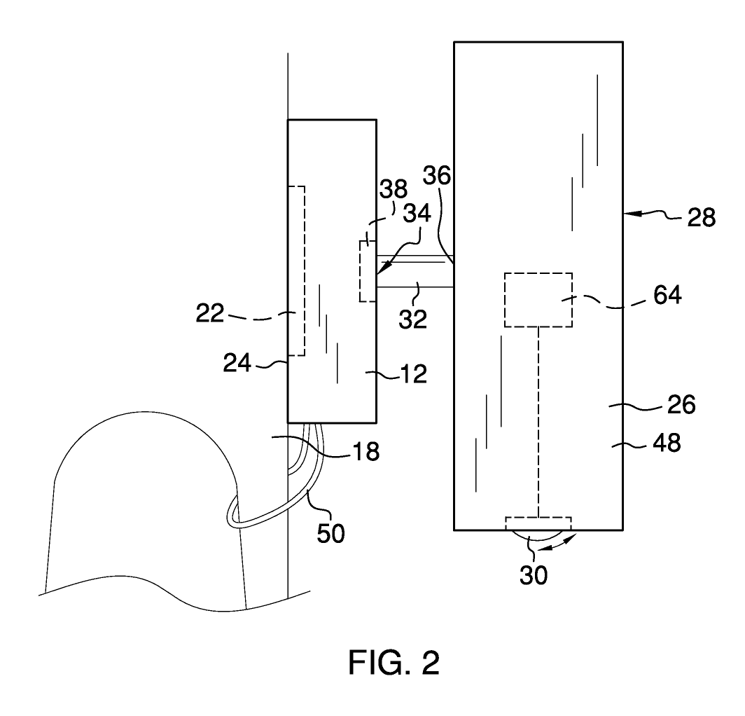

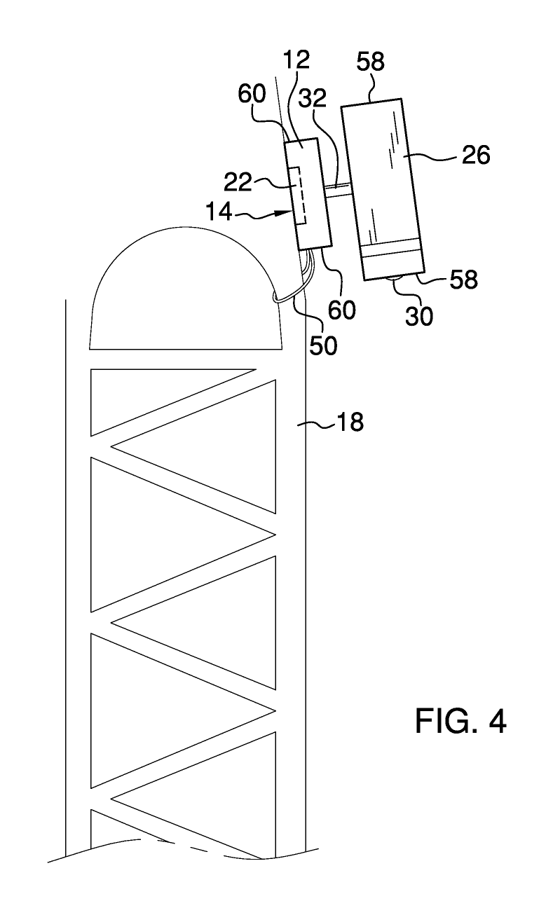

A rod 32 extends between the base 12 and the camera 26. A first end 34 of the rod 32 is coupled to and rotatable relative to the base 12. A second end 36 of the rod 32 is fixedly coupled to the camera 26. The center of gravity of the camera 26 is positioned between the lens 30 and the second end 36 of the rod 32 to maintain the downward orientation of the lens 30 described above. A bearing 38, bushing, or the like, is coupled to the rod 32 and the base 12 wherein the bearing 38 facilitates free rotation of the rod 32 relative to the base 12. The camera 26 may have an elongated body 48 as shown in FIGS. 1 and 2 and the rod 32 may be offset from the center. Alternatively, the camera 32 may be more compact as seen in FIG. 4 such that an outer perimeter 60 of the base 12 extends outwardly beyond the edges 58 of the camera 26. A weight 74 may be coupled to the camera 26 to facilitate proper orientation of the center of gravity as described above.

A monitor 40 is provided extrinsic to the base 12 and camera 26. The camera 26 provides images to be viewed on a display screen 42 of the monitor 40. Thus, the camera 26 is configured for showing images of a bucket 44 or hook 68 coupled to the boom arm 18 when the camera 26 is coupled to the boom arm 18 substantially in vertical alignment with the bucket 44. Operational controls 46 of a conventional manner such as focus, zoom, and the like, are coupled to the monitor 40. The operational controls 46 are communicatively coupled to the camera 26 by a transmitter 48 communicating with a receiver 64 in the camera 26 such that the camera 26 is operable by manipulation of the operational controls 46. Additionally, the lens 30 may be adjustable relative to a body 48 of the camera 26 to allow for adjustment of the direction of the lens 30. Such adjustments may also be controlled by the operational controls 46 in a conventional manner.

A tether 50 is coupled to the base 12 wherein the tether 50 is configured for preventing the base 12 and camera 26 from falling completely from the boom arm 18 upon disengagement of the magnet 22 from the boom arm 18.

In use, the base 12 is positioned on the boom arm 18 at a desired location to provide substantial vertical alignment with the bucket 44. The monitor 40 is used to monitor the bucket 44 and lateral spacing between the bucket 44 and other objects which may be otherwise screened from the view of an operator of the crane 20.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A crane boom camera device comprising:
a base;
a coupler coupled to said base wherein said base is configured for coupling said base to a distal end of a boom arm relative to a cab of a crane;
a camera being pivotally coupled to said base, a center of gravity of said camera being offset from a pivot point of said camera and said base such that a lens of said camera faces downward; and
a monitor, said camera providing images to be viewed on said monitor such that said camera is configured for showing images of a bucket coupled to said boom arm when said camera is coupled to said boom arm substantially in vertical alignment with said bucket.

2. The device of claim 1, further comprising said coupler being a magnet.

3. The device of claim 2, further comprising a tether coupled to said base wherein said tether is configured for preventing said base from falling from the boom arm upon disengagement of said magnet from the boom arm.

4. The device of claim 1, further comprising operational controls coupled to said monitor, said operational controls being communicatively coupled to said camera such that said camera is operable by manipulation of said operational controls.

5. The device of claim 1, further comprising a rod extending between said base and said camera, said rod being rotatable relative to said base.

6. The device of claim 5, further comprising a bearing coupled to said rod and said base wherein said bearing facilitates free rotation of said rod relative to said base.

7. The device of claim 1, further comprising said base being disc-shaped.

8. A crane boom camera device comprising:
a base, said base being disc-shaped;
a coupler coupled to said base wherein said base is configured for coupling said base to a distal end of a boom arm relative to a cab of a crane, said coupler being a magnet, said coupler being centrally positioned on a face of said base, said coupler being flush with said face of said base;
a camera being pivotally coupled to said base, a center of gravity of said camera being offset from a pivot point of said camera and said base such that a lens of said camera faces downward;
a rod extending between said base and said camera, said rod being rotatable relative to said base;
a bearing coupled to said rod and said base wherein said bearing facilitates free rotation of said rod relative to said base;
a monitor, said camera providing images to be viewed on said monitor such that said camera is configured for showing images of a bucket coupled to said boom arm when said camera is coupled to said boom arm substantially in vertical alignment with said bucket;
operational controls coupled to said monitor, said operational controls being communicatively coupled to said camera such that said camera is operable by manipulation of said operational controls; and
a tether coupled to said base wherein said tether is configured for preventing said base from falling from the boom arm upon disengagement of said magnet from the boom arm.
